(19) United States
(12) Patent Application Publication
(10) Pub. No.: US 2011/0310001 A1
(43) Pub. Date: Dec. 22, 2011

(54) DISPLAY RECONFIGURATION BASED ON FACE/EYE TRACKING

(75) Inventors: Dinu Petre Madau, Canton, MI (US); John Robert Balint, Ann Arbor, MI (US); Jill Baty, Novi, MI (US)

(73) Assignee: Visteon Global Technologies, Inc, Van Buren Twp, MI (US)

(21) Appl. No.: 12/816,748

(22) Filed: Jun. 16, 2010

(51) Int. Cl. G09G 5/00

(52) U.S. Cl. 345/156

(57) ABSTRACT

An adaptive interface system includes a user interface providing a visual output, a sensor for detecting a vision characteristic of a user and generating a sensor signal representing the vision characteristic, and a processor in communication with the sensor and the user interface, wherein the processor receives the sensor signal, analyzes the sensor signal based upon an instruction set to determine the vision characteristic of the user, and reconfigures the visual output of the user interface based upon the vision characteristic of the user to highlight at least a portion the visual output within a field of focus of the user.

### FIELD OF THE INVENTION

The present invention relates generally to a reconfigurable display. In particular, the invention is directed to an adaptive interface system and a method for display reconfiguration based on a tracking of a user.

### BACKGROUND OF THE INVENTION

Eye-tracking devices detect the position and movement of an eye. Several varieties of eye-tracking devices are disclosed in U.S. Pat. Nos. 2,288,430; 2,445,787; 3,462,604; 3,514,193; 3,534,273; 3,583,794; 3,806,725; 3,864,030; 3,992,087; 4,003,642; 4,034,401; 4,075,657; 4,102,564; 4,145,122; 4,169,663; and 4,303,394.

Currently, eye tracking devices and methods are implemented in vehicles to detect drowsiness and erratic behavior in a driver of a vehicle as well as enable hands-free control of certain vehicle systems.

However, conventional in-vehicle user interfaces and instrument clusters include complex displays having multiple visual outputs presented thereon. Additionally, conventional in-vehicle user interfaces include a variety of user-engagable functions in the form of visual outputs such as buttons, icons, and menus, for example. The various visual outputs presented to a driver of a vehicle can be distracting to the driver and can often draw the attention of the driver away from the primary task at hand (i.e. driving).

It would be desirable to develop an adaptive user interface wherein a visual output of the user interface is automatically configured based upon a vision characteristic of a user to highlight the visual output within a field of focus of the user.

### SUMMARY OF THE INVENTION

Concordant and consistent with the present invention, an adaptive user interface wherein a visual output of the user interface is automatically configured based upon a vision characteristic of a user to highlight the visual output within a field of focus of the user, has surprisingly been discovered.

In one embodiment, an adaptive interface system comprises: a user interface providing a visual output; a sensor for detecting a vision characteristic of a user and generating a sensor signal representing the vision characteristic; and a processor in communication with the sensor and the user interface, wherein the processor receives the sensor signal, analyzes the sensor signal based upon an instruction set to determine the vision characteristic of the user, and configures the visual output of the user interface based upon the vision characteristic of the user to highlight at least a portion the visual output within a field of focus of the user.

In another embodiment, an adaptive interface system for a vehicle comprises: a user interface disposed in an interior of the vehicle, the user interface having a display for communicating an information to a user representing a condition of a vehicle system; a sensor for detecting a vision characteristic of a user and generating a sensor signal representing the vision characteristic; and a processor in communication with the sensor and the user interface, wherein the processor receives the sensor signal, analyzes the sensor signal based upon an instruction set to determine the vision characteristic of the user, and configures the display based upon the vision characteristic of the user to emphasize a particular visual output presented on the display.

The invention also provides methods for configuring a display.

One method comprises the steps of: providing a display to generate a visual output; providing a sensor to detect a vision characteristic of a user; and configuring the visual output of the display based upon the vision characteristic of the user to highlight at least a portion of the visual output within a field of focus of the user.

### BRIEF DESCRIPTION OF THE DRAWINGS

The above, as well as other advantages of the present invention, will become readily apparent to those skilled in the art from the following detailed description of the preferred embodiment when considered in the light of the accompanying drawings in which:

FIG. 1 is a fragmentary perspective view of an interior of a vehicle including an adaptive interface system according to an embodiment of the present invention;

FIG. 2 is a schematic block diagram of the interface system of FIG. 1; and

FIGS. 3A-3B are fragmentary front elevational views of an instrument cluster display of the interface system of FIG. 1.

### DETAILED DESCRIPTION OF EXEMPLARY EMBODIMENTS OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

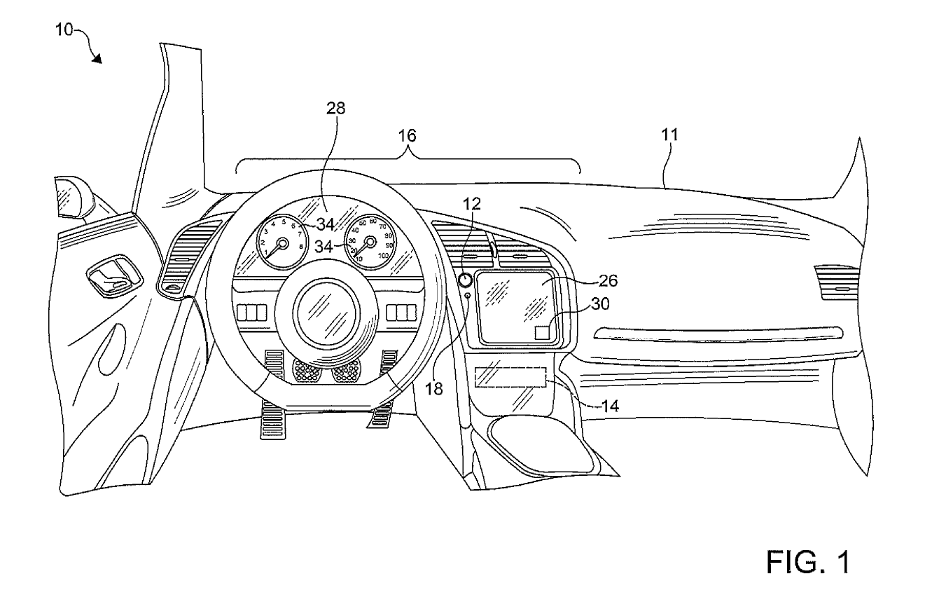

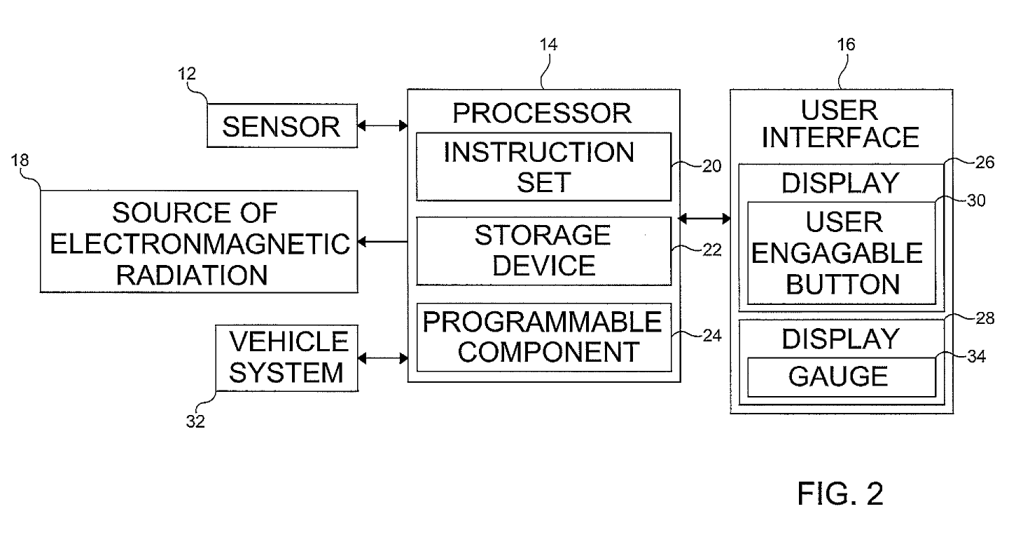

FIGS. 1-2 illustrate an adaptive interface system 10 for a vehicle 11 according to an embodiment of the present invention. As shown, the interface system 10 includes a sensor 12, a processor 14, and a user interface 16. The interface system 10 can include any number of components, as desired. The interface system 10 can be integrated in any user environment.

The sensor 12 is a user tracking device capable of detecting a vision characteristic of a face or head of a user (e.g. a head pose, a gaze vector or direction, a facial feature, and the like.). In certain embodiments, the sensor 12 is a complementary metal-oxide-semiconductor (CMOS) camera for capturing an image of at least a portion of a head (e.g. face or eyes) of the user and generating a sensor signal representing the image. However, other cameras and image capturing devices can be used. As a non-limiting example, a source of radiant energy 18 is disposed to illuminate at least a portion of a head of the user. As a further non-limiting example, the source of radiant energy 18 may be an infra-red light emitting diode. However, other sources of the radiant energy can be used.

The processor 14 may be any device or system adapted to receive an input signal (e.g. the sensor signal), analyze the input signal, and configure the user interface 16 in response to the analysis of the input signal. In certain embodiments, the processor 14 is a micro-computer. In the embodiment shown, the processor 14 receives the input signal from at least one of the sensor 12 and a user-provided input via the user interface 16.

As shown, the processor 14 analyzes the input signal based upon an instruction set 20. The instruction set 20, which may be embodied within any computer readable medium, includes processor executable instructions for configuring the processor 14 to perform a variety of tasks. The processor 14 may execute a variety functions such as controlling the operation of the sensor 12 and the user interface 16, for example. It is understood that various algorithms and software can be used to analyze an image of a head, a face, or an eye of a user to determine the vision characteristics thereof (e.g. the “Smart Eye” software produced by Smart Eye AB in Sweden). It is further understood that any software or algorithm can be used to detect the vision characteristics of the head/face of the user such as the techniques described in U.S. Pat. Nos. 4,648,052, 4,720,189, 4,836,670, 4,950,069, 5,008,946 and 5,305,012, for example.

As a non-limiting example, the instruction set 20 is a learning algorithm adapted to determine at least one of a head pose, a gaze vector, and an eyelid tracking of a user based upon the information received by the processor 14 (e.g. via the sensor signal). As a further non-limiting example, the processor 14 determines a field of focus of at least one of the eyes of a user, wherein a field of focus is a pre-determined portion of a complete field of view of the user. In certain embodiments, the field of focus is defined by a pre-determined range of degrees (e.g. +/−five degrees) from a gaze vector calculated in response to the instruction set 20. It is understood that any range degrees relative to the calculated gaze vector can be used to define the field of focus.

In certain embodiments, the processor 14 includes a storage device 22. The storage device 22 may be a single storage device or may be multiple storage devices. Furthermore, the storage device 22 may be a solid state storage system, a magnetic storage system, an optical storage system or any other suitable storage system or device. It is understood that the storage device 22 may be adapted to store the instruction set 20. Other data and information may be stored and cataloged in the storage device 22 such as the data collected by the sensor 12 and the user interface 16, for example.

The processor 14 may further include a programmable component 24. It is understood that the programmable component 24 may be in communication with any other component of the interface system 10 such as the sensor 12 and the user interface 16, for example. In certain embodiments, the programmable component 24 is adapted to manage and control processing functions of the processor 14. Specifically, the programmable component 24 is adapted to modify the instruction set 20 and control the analysis of the signals and information received by the processor 14. It is understood that the programmable component 24 may be adapted to manage and control the sensor 12 and the user interface 16. It is further understood that the programmable component 24 may be adapted to store data and information on the storage device 22, and retrieve data and information from the storage device 22.

As shown, the user interface 16 includes a plurality of displays 26, 28 for presenting a visible output to the user. It is understood that any number of the displays 26, 28 can be used, including one. It is further understood that any type of display can be used such as a two dimensional display, a three dimensional display, a touch screen, and the like.

In the embodiment shown, the display 26 is a touch sensitive display (i.e. touch screen) having a user-engageable button 30 presented thereon. The button 30 is associated with an executable function of a vehicle system 32 such as a navigation system, a radio, a communication device adapted to connect to the Internet, and a climate control system, for example. However, any vehicle system can be associated with the user-engageable button 30. It is further understood that any number of the buttons 30 can be included and disposed in various locations throughout the vehicle 11 such as on a steering wheel, for example.

The display 28 is a digital instrument cluster to display a digital representation of a plurality of gauges 34 such as a gas gauge, a speedometer, and a tachometer, for example. In certain embodiments, the user interface 16 includes visual elements integrated with a dashboard, a center console, and other components of the vehicle 11.

In operation, the user interacts with the interface system 10 in a conventional manner. The processor 14 continuously receives the input signals (e.g. sensor signal) and information relating to the vision characteristics of the user. The processor 14 analyzes the input signal and the information based upon the instruction set 20 to determine the vision characteristics of the user. The user interface 16 is automatically configured by the processor 14 based upon the vision characteristics of the user. As a non-limiting example, the processor 14 automatically configures the visible output presented on at least one of the displays 26, 28 in response to the detected vision characteristics of the user. As a further non-limiting example, the processor configures an executable function associated with the visible output (e.g. the button 30) presented on the display 26 based upon the vision characteristics of the user.

In certain embodiments, the processor 14 analyzes the input signal to determine an eyelid position of the user, wherein a pre-determined position (e.g. closed) activates the user-engageable button 30 presented on the display 26. It is understood that a threshold gaze time can be used to activate the button 30, as is known in the art.

In certain embodiments, the visual output of at least one of the displays 26, 28 is configured to provide the appearance of a three dimensional perspective to provide realism such as changing the graphics perspective to follow a position of a head of the user. It is understood that any three-dimensional technology known in the art can be used to produce the three dimensional perspective.

It is understood that the user can manually modify the configuration of the displays 26, 28 and the executable functions associated therewith. It is further understood that the user interface 16 may provide a selective control over the automatic configuration of the display 26, 28. For example, the displays 26, 28 may always revert to the default configuration unless the user initiates a vision mode, wherein the user interface 16 is automatically configured to the personalized configuration associated with the vision characteristics of the user.

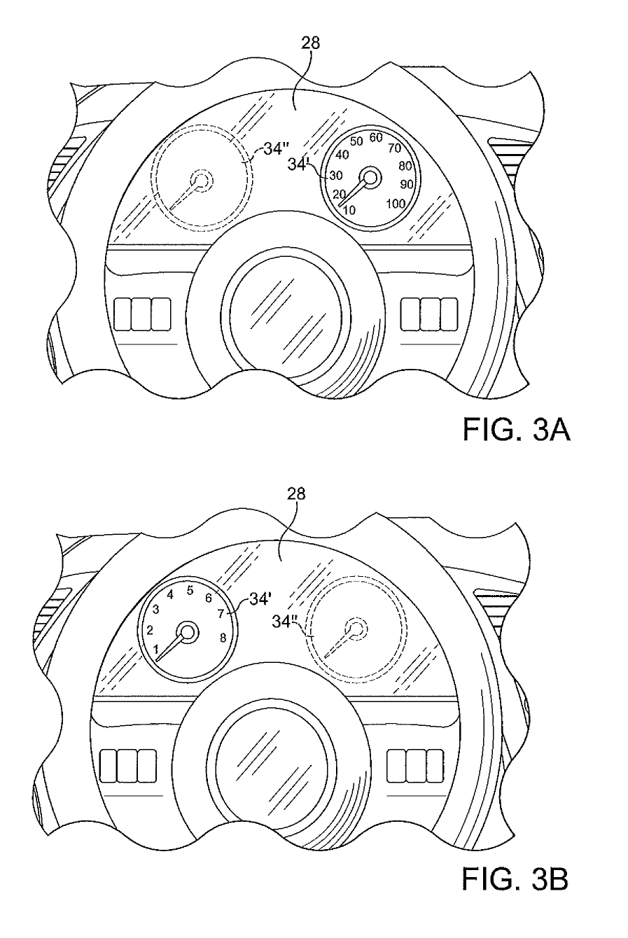

An example of a personalized configuration is shown in FIGS. 3A and 3B. As shown in FIG. 3A the user is gazing toward a rightward one of the gauges 34 and the rightward one of the gauges 34 is within a field of focus of the user. Accordingly, the rightward one of the gauges 34 becomes a focus gauge 34′ and the other visual output (e.g. a non-focus gauge 34″) is diminished. For example, the focus gauge 34′ can be illuminated with a greater intensity than the non focus gauge 34″. As a further example, the focus gauge 34′ may be enlarged on the display 28 relative to a size of the non-focus gauge 34″.

As shown in FIG. 3B the user is gazing toward a leftward one of the gauges 34 and the leftward one of the gauges 34 is within a field of focus of the user. Accordingly, the leftward one of the gauges 34 becomes the focus gauge 34′ and the non-focus gauge 34″ is diminished. For example, the focus gauge 34′ can be illuminated with a greater intensity than the non focus gauge 34″. As a further example, the focus gauge 34′ may be enlarged on the display 28 relative to a size of the non-focus gauge 34″.

In certain embodiments, only the visual output within the field of focus of the user is fully illuminated, while the visual output outside of the field of focus of the user is subdued or made invisible. As the vision characteristics of the user change, the user interface 16 is automatically configured to highlight or emphasize the visual output of the displays 26, 28 within the field of focus of the user. It is understood that any visual output of the user interface 16 can be configured in a similar fashion as the gauges 34′, 34″ of the above example such as the button 30, for example. It is further understood that various configurations of the user interface 16 can be used based upon any level of change to the vision characteristics of the user.

The interface system 10 and methods of configuring the user interface 16 provide a real-time personalization of the user interface 16 based upon the vision characteristics of the user, thereby focusing the attention of the user to the visual output of interest (i.e. within the field of focus) and minimizing the distractions presented by non-focus visual outputs.

From the foregoing description, one ordinarily skilled in the art can easily ascertain the essential characteristics of this invention and, without departing from the spirit and scope thereof, make various changes and modifications to the invention to adapt it to various usages and conditions.

What is claimed is:

1. An adaptive interface system comprising:
a user interface providing a visual output;
a sensor for detecting a vision characteristic of a user and generating a sensor signal representing the vision characteristic; and
a processor in communication with the sensor and the user interface, wherein the processor receives the sensor signal, analyzes the sensor signal based upon an instruction set to determine the vision characteristic of the user, and configures the visual output of the user interface based upon the vision characteristic of the user to highlight at least a portion of the visual output within a field of focus of the user.

2. The interface system according to claim 1, wherein the user interface is a touch screen.

3. The interface system according to claim 1, wherein the user interface includes a user-engageable button associated with an executable function.

4. The interface system according to claim 1, wherein the user interface is disposed in an interior of a vehicle.

5. The interface system according to claim 1, wherein the user interface is a digital instrument cluster having a gauge.

6. The interface system according to claim 1, wherein the sensor is a tracking device for capturing an image of the user.

7. The interface system according to claim 1, wherein the instruction set is a learning algorithm for determining at least one of a head pose of the user, a gaze direction of the user, and an eyelid position of the user.

8. The interface system according to claim 1, further comprising a source of electromagnetic radiation to illuminate a portion of the user to facilitate the detecting of the vision characteristic of the user.

9. An adaptive interface system for a vehicle comprising:
a user interface disposed in an interior of the vehicle, the user interface having a display for communicating an information to a user representing a condition of a vehicle system;
a sensor for detecting a vision characteristic of a user and generating a sensor signal representing the vision characteristic; and
a processor in communication with the sensor and the user interface, wherein the processor receives the sensor signal, analyzes the sensor signal based upon an instruction set to determine the vision characteristic of the user, and configures the display based upon the vision characteristic of the user to emphasize a particular visual output presented on the display.

10. The interface system according to claim 9, wherein the display of the user interface is a touch screen.

11. The interface system according to claim 9, wherein the display includes a user-engageable button associated with an executable function.

12. The interface system according to claim 9, wherein the sensor is a user tracking device capable of capturing an image of the user.

13. The interface system according to claim 9, wherein the instruction set is a learning algorithm for determining at least one of a head pose of the user, a gaze direction of the user, and a eyelid position of the user.

14. The interface system according to claim 9, wherein the processor configures the display based upon vision characteristic of the user to highlight a portion of the visual output within a field of focus of the user.

15. A method of configuring a display, the method comprising the steps of:
providing a display to generate a visual output;
providing a sensor to detect a vision characteristic of a user; and
configuring the visual output of the display based upon the vision characteristic of the user to highlight at least a portion of the visual output within a field of focus of the user.

16. The method according to claim 15, wherein the display is a touch screen.

17. The method according to claim 15, wherein the display includes a user-engageable button associated with an executable function.

18. The method according to claim 15, wherein the display is disposed in an interior of a vehicle.

19. The method according to claim 15, wherein the sensor is a user tracking device capable of capturing an image of the user.

20. The method according to claim 15, wherein the instruction set is a learning algorithm for determining at least one of a head pose of the user, a gaze direction of the user, and a eyelid position of the user.
